(19) United States
(12) Patent Application Publication
(10) Pub. No.: US 2024/0407030 A1
(43) Pub. Date: Dec. 5, 2024

(54) WIRELESS RELAY COMMUNICATION SCHEMES

(71) Applicant: ZTE Corporation, Shenzhen (CN)

(72) Inventors: Wanfu XU, Shenzhen (CN); Mengzhen WANG, Shenzhen (CN); Tao QI, Shenzhen (CN); Lin CHEN, Shenzhen (CN)

(73) Assignee: ZTE Corporation, Shenzhen (CN)

(21) Appl. No.: 18/802,570

(22) Filed: Aug. 13, 2024

Related U.S. Application Data
(63) Continuation of application No. PCT/CN2022/076133, filed on Feb. 14, 2022.

(51) Int. Cl. H04W 76/15; H04W 24/08; H04W 48/10; H04W 48/16

(52) U.S. Cl. CPC H04W 76/15; H04W 24/08; H04W 48/10; H04W 48/16

(57) ABSTRACT

A method of wireless communication is described. The wireless communication method includes detecting, at a first device requesting to communication with a third device, a low link quality of a first link associated with the first device or the third device, the low link quality being below a link quality threshold; broadcasting, after the detecting the low link quality, a message to discover a second device capable of establishing a second link with the first device or the third device; and communicating with the third device via the second device using the second link.

### CROSS-REFERENCE TO RELATED APPLICATIONS

This application is a continuation of International Patent Application No. PCT/CN2022/076133, filed on Feb. 14, 2022, the contents of which are incorporated herein by reference in their entirety.

### TECHNICAL FIELD

This patent document generally relates to systems, devices, and techniques for wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices.

### SUMMARY

This document relates to methods, systems, and devices for feedback schemes for multiple channels in wireless communication devices.

In one aspect, a wireless communication method is disclosed. The wireless communication method includes detecting, at a first device requesting to communication with a third device, a low link quality of a first link associated with the first device or the third device, the low link quality being below a link quality threshold; broadcasting, after the detecting the low link quality, a message to discover a second device capable of establishing a second link with the first device or the third device; and communicating with the third device via the second device using the second link.

In another aspect, a wireless communication method is disclosed. The wireless communication method includes receiving, at a first device capable of assisting communications between a second device and a third device, a first message, from the second device, to request to communicate with the third device via the first device; measuring a link quality between the second device and the first device and comparing the measured link quality with a link quality threshold; and broadcasting a second message to the third device based on a result of the comparison of the measured link quality such that the second device engages in a communication with the third device via the first device.

In another aspect, a wireless communication method is disclosed. The wireless communication method includes performing, at a first device, a group member discovery to discover a second device and a third device that are to be in communication with each other via the first device; and periodically broadcasting, upon discovering the second device and the third device, announcement messages to the second device and the third device.

In another aspect, a wireless communication method is disclosed. The wireless communication method includes receiving, at a first device, first messages, from multiple second devices, each first message requesting the first device to establish a link between the first device and a corresponding second device; selecting, among the multiple second devices, one second device to be used in a communication with the first device based on the received first messages; and transmitting a second message to establish a link between the first device and the one second device.

In another aspect, a wireless communication method is disclosed. The wireless communication method includes receiving, at a first device, a first message to establish a connection with a second device via a third device, the first message including configuration information specified for a communication between the first device and the second device; performing a configuration based on the configuration information included in the first message; and transmitting a second message to the third device using the configuration information included in the first message, the second message to be forwarded to the second device to notify the second device a completion of an establishment of the connection between the first device and the second device.

In another aspect, a communication apparatus comprising a processor configured to implement the above-described method is disclosed.

In another aspect, a computer readable medium having code stored thereon, the code, when executed, causing a processor to implement the above-described method is disclosed.

These, and other features, are described in the present document.

### BRIEF DESCRIPTION OF THE DRAWING

FIG. 1A shows a schematic diagram illustrating a UE-to-Network relay communication.

FIG. 1B shows a schematic diagram illustrating a UE-to-UE relay communication.

FIG. 2 shows a schematic diagram illustrating example operations including finding a relay UE using a direct link quality based on some implementations of the disclosed technology.

FIG. 3 shows a schematic diagram illustrating example operations including finding a relay UE using an indirect link quality based on some implementations of the disclosed technology.

FIG. 4 shows a schematic diagram illustrating example operations including deciding to participate the procedure based on some implementations of the disclosed technology.

FIG. 5 shows a schematic diagram illustrating example operations using Group Member Discovery procedures based on some implementations of the disclosed technology.

FIG. 6 shows a schematic diagram illustrating example operations including selecting one relay UE using link quality information based on some implementations of the disclosed technology.

FIG. 7 shows a schematic diagram illustrating example operations including selecting one relay UE using information included in a based on some implementations of the disclosed technology.

FIG. 8 shows a schematic diagram illustrating example operations including selecting one relay UE using timer and path selection information based on some implementations of the disclosed technology.

FIG. 9 shows a schematic diagram illustrating example operations including selection of the relay UE by the source UE based on some implementations of the disclosed technology.

FIG. 10 shows a schematic diagram illustrating example operations including informing the occurrence of a radio link failure.

FIG. 11-16 illustrate a flowchart showing an example method of wireless communication based on some implementations of the disclosed technology.

FIG. 17 shows an example of wireless communication including a base station (BS) and user equipment (UE) based on some implementations of the disclosed technology.

FIG. 18 shows an example of a block diagram of a portion of an apparatus based on some implementations of the disclosed technology.

### DETAILED DESCRIPTION

The disclosed technology provides implementations and examples of wireless relay communication schemes.

With the development of wireless multimedia services, people's demands for high data rate and user experience are increasing day by day, which puts forward higher requirements on the system capacity and coverage of traditional cellular networks. On the other hand, application scenarios such as public safety, social networking, close-range data sharing, and local advertising have gradually increased the need for people to understand and communicate with nearby people or things (Proximity Services). The traditional base station-centric cellular network has obvious limitations in terms of high data rate and support for proximity services. In this context, device-to-device (D2D) communication technology emerges to overcome the limitations and satisfy the needs. The application of D2D technology can reduce the burden of cellular networks, reduce battery power consumption of user equipment, increase data rate, and improve the robustness of network infrastructure, which can well meet the above-mentioned requirements of high data rate services and proximity services. D2D technology is also called Proximity Services (ProSe), unilateral/sidechain/Sidelink (SL) communication; the interface between devices is PC5 interface.

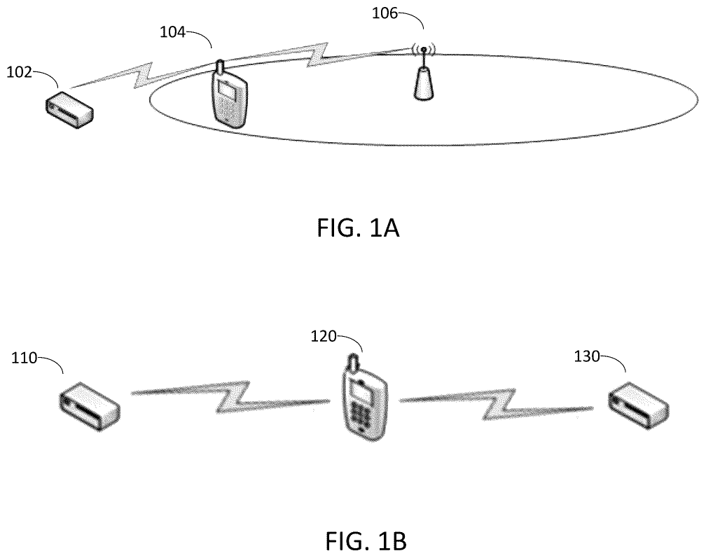

In order to support a wider range of applications and services, sidelink-based relay communication can extend coverage and improve power consumption, such as in indoor relay communication, smart agriculture, smart factories, public safety, etc. There are two main application scenarios for sidelink relay communication:
1) UE-to-Network relay: The UE relay transmission in weak/no coverage area, such as mode 1 in FIG. 1A, allows the first UE 102 with poor signal quality or no coverage to communicate with the network 106 through the second UE 104 with nearby network coverage. The communication can help operators expand coverage and increase capacity. The second UE 104 is called UE-to-Network relay, and the first UE 102 is called UE-to-Network remote UE. FIG. 1A shows a schematic diagram illustrating a UE-to-Network relay.
2) UE-to-UE relay: In the event of an earthquake or emergency, the cellular network cannot work normally or in order to expand the communication range of the sidelink, allowing devices to communicate through the relay UE. FIG. 1B shows a schematic diagram illustrating a UE-to-UE relay. In FIG. 1B, the first UE 110 and the third UE 130 are both within range of the second UE 120, while the first UE 110 and third UE 130 are outside of a communication range. In the UE-to-UE relay communication scenario, the second UE 120 operates as a UE-to-UE communications between the first and third UEs 110 and 130 and thus the first UE 110 and the third UE 130 can communicate each other via the second UE 120.

LTE provides two UE-to-Network relay technical solutions based on IP layer (Layer 3, Layer 3) and access layer (Layer 2, Layer 2). Among them, layer 3 (IP layer) relay, that is, forwarding data according to information such as the target IP address/port number; layer 2 (access layer) relay, that is, relay UE performs routing and forwarding of control plane and user plane data at the access layer, which can enable operators (ie, core network elements and base stations) to manage remote equipment (remote UE) more effectively. Because NR sidelink communication and LTE sidelink communication mechanism are quite different, such as frame structure, QoS processing, bearer configuration and establishment, etc., the LTE-based sidelink relay technical solution is not suitable for 5G/NR system. For a mobile UE, when the signal quality is poor or out of coverage, the relay UE helps it forward data with the network/UE, and how to perform the discovery and selection/reselection of the relay UE is a problem that needs to be solved.

Various implementations of the disclosed technology relate to relay techniques in wireless communications. Some implementations of the disclosed technology are related to the UE—to UE relay technique or the UE—to network relay techniques. In some implementations, the source UE communicates with the target UE through the relay UE. Various implementations of the disclosed technology provide techniques for finding a relay UE by either a source UE or a target UE, deciding by a relay UE to participate the relay service procedure, performing a relay selection by a source UE, and/or informing by a relay station a radio link failure. In some implementations, the remote UE communicates with the network via the relay UE.

### Implementation 1—Source UE Finding Relay UE When Direct Link Quality Is Below Threshold

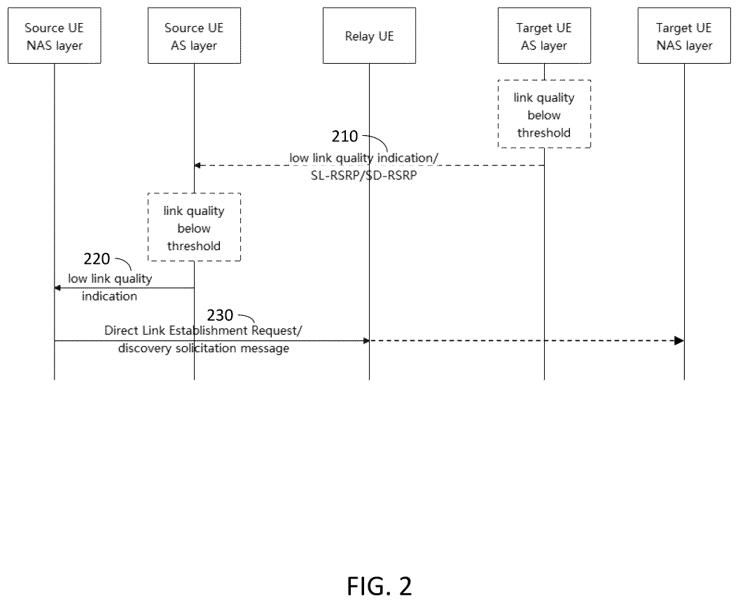

This implementation discusses the techniques for finding a relay UE when the link quality between the source UE and the target UE is below the threshold. FIG. 2 shows a schematic diagram illustrating example operations including finding a relay UE using a direct link quality based on some implementations of the disclosed technology. In FIG. 2, the NAS (Non-Access Stratum) layer and the AS (Access Stratum) layer are shown for each of the source UE and the target UE.

Operation 210: The link quality between the source UE and the target UE is measured by the target UE or the source UE. In some implementations, the link quality may correspond to Sidelink Reference Signal Received Power (SL-RSRP) or Sidelink Discovery Reference Signal Received Power (SD-RSRP). In some implementations, the AS layer of the source UE measures the link quality between the source UE and the target UE. In some other implementations, the AS layer of the target UE measures that the link quality between the source UE and the target UE. The UE-to-UE relay techniques enable the communication between the source UE and the target UE when the measured link quality between the source UE and the target UE is lower than the threshold. The threshold can be configured by network or system information or pre-configuration. If the source UE or the target UE is out of coverage, the threshold is configured by pre-configuration. If the source UE or the target UE is in an IDLE/INACTIVE state (e.g., RRC IDLE/INACTIVE), the threshold is configured by system information. If the source UE or the target UE is in a CONNECTED state (e.g., RRC CONNECTED), the threshold is configured by system information or dedicated signaling (e.g., RRC signaling).

If the AS layer of the target UE measures the link quality between the source UE and the target UE and the measured link quality is lower than the threshold, the target UE informs the source UE the low link quality by sending the low link quality indication. If the AS layer of the source UE measures the link quality between the source UE and the target UE and the measured link quality is lower than the threshold, the AS layer of source UE informs the NAS layer of the source UE of the low link quality by sending the low link quality indication. In some implementation, the low link quality indication is sent via a communication protocol such as PC5-RRC.

Operation 220: The AS layer of the source UE sends low link quality indication to the NAS (Non-Access Stratum) layer of the source UE. In some implementations, the AS layer of the source UE receives the low link quality indication from the AS layer of the target UE and sends the low link quality indication to the NAS layer of the source UE. In some implementations, the AS layer of the source UE receive the low link quality indication from the source UE measures the link quality between the source UE and the target UE and sends the low link quality indication to the source UE NAS layer. By receiving the low link quality indication, the NAS layer of the source UE detects the low link quality between the source UE and the target UE.

Operation 230: The NAS layer of the source UE broadcasts a Direct Link Establishment Request message or discovery solicitation message to find a U2U relay UE which is able to link the source UE to the target UE.

In some implementations, the NAS layer of the source UE broadcasts the Direct Link Establishment Request message. The Direct Link Establishment Request message is used for a sidelink UE (source UE) to establish a direct link or indirect link with another sidelink UE (target UE). The direct link refers to the direct communication between the source UE and the target UE, while the indirect link refers to the indirect communication between the source UE and the target UE via a relay UE. The field, relay_indication, may be included in Direct Link Establishment Request message. If the relay_indication field is enabled, it means the communication between the source UE and the target UE via relay UE is allowed. If the relay_indication field is disabled, the communication between the source UE and the target UE via a relay UE is not allowed and only direct communication between source UE and target UE is allowed. The Direct Link Establishment Request message can be sent to any UE, e.g., the target UE or the relay UE, to request to establish the link between two UEs. Thus, the Direct Link Establishment Request message sent from the source UE NAS layer can be received by the relay UE or the target UE.

In some implementations, the NAS layer of the source UE broadcasts the discovery solicitation message to find the relay UE. The discovery solicitation message can be sent to the relay UE and the target UE.

### Implementation 2-Source UE Finding Relay UE When Indirect Link Quality Is Below Threshold

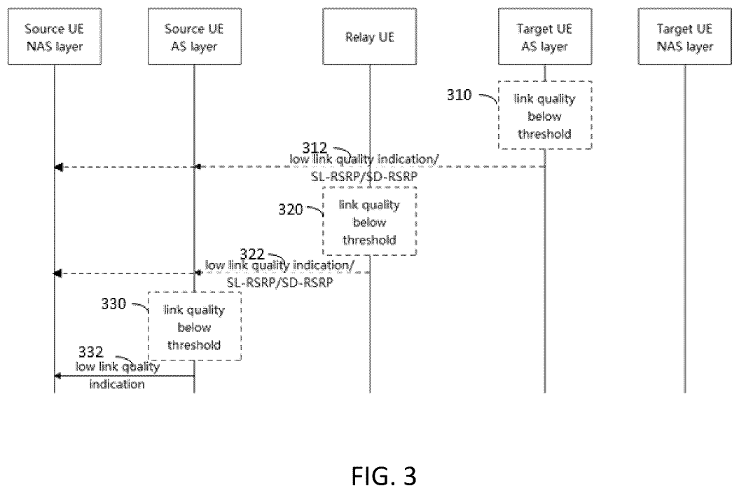

This implementation discusses the scenario when an existing relay UE assisting the source UE to engage in the communication with the target UE has a poor connection with either the source UE or the target UE. In the implementation, the source UE finds a new relay UE or directly communicates with the target UE. FIG. 3 shows a schematic diagram illustrating example operations including finding a relay UE using an indirect link quality based on some implementations of the disclosed technology.

Operation 310, 320, or 330: The link quality is measured at the target UE, the relay UE, or the source UE. Thus, one of operations 310, 320, or 330 can be performed. In some implementations, the link quality may correspond to Sidelink Reference Signal Received Power (SL-RSRP) or Sidelink Discovery Reference Signal Received Power (SD-RSRP). In the implementation, the measured link quality is below the threshold, which results in finding another relay UE. The threshold can be determined various manners, for example, by network or system information or pre-configuration. As discussed for Implementation 1, if the source UE or the target UE is out of coverage, the threshold is configured by pre-configuration. If the source UE or the target UE is in an IDLE/INACTIVE state (e.g., RRC IDLE/INACTIVE), the threshold is configured by system information. If the source UE or the target UE is in a CONNECTED state (e.g., RRC CONNECTED), the threshold is configured by system information or dedicated signaling (e.g., RRC signaling). The threshold in Implementation 2 can be same or different from the threshold in Implementation 1.

In the operation 310, the target UE measures the link quality between the relay UE and the target UE. In the operation 330, the source UE measures the link quality between the relay UE and the source UE. In the operation 320, the relay UE measures the link quality between the source UE and the relay UE or the link quality between the relay UE and the target UE.

Operation 312, 322 or 332: Since the measurement of the link quality is below the threshold, the AS layer of the source UE, the relay UE, or the target UE sends the low link quality indication. By receiving the low link quality indication from the AS layer of the source UE, the relay UE, or the target UE, the NAS layer of the source UE detects the low link quality between the source UE and the target UE, the low link quality between the source UE and the relay UE, or the low link quality between the relay UE and the target UE.

When the target UE measures the link quality between the source UE and the target UE, the target UE sends the low link quality indication to the source UE (see operation 312) In some implementations, the target UE sends the low link quality indication to the AS layer of the source UE and then the AS layer of the source UE sends the low link quality indication to the NAS layer of the source UE. When the relay UE measures the link quality between the source UE and the relay UE or between the relay UE and the target UE, the relay UE informs the source UE of the low link quality by sending the low link quality indication (see operation 322). In some implementations, the target UE sends the low link quality indication to the AS layer of the source UE and then the AS layer of the source UE sends the low link quality indication to the NAS layer of the source UE. When the AS layer of the source UE measures the link quality between the source UE and the target UE, the AS layer of the source UE sends the low link quality indication to the NAS layer of the source UE (see operation 332). In some implementation, the low link quality indication can be sent via a sidelink control channel such as PC5-RRC.

Operation 340 (not shown): The NAS layer of the source UE, which receives the low link quality indication from the AS layer of the source UE, the relay UE, or the target UE, broadcasts a Direct Link Establishment Request message or discovery solicitation message to find a new relay UE which is able to link the source UE to the target UE. The new relay UE may have a better signal quality with the source UE or the target UE as compared to the existing relay UE.

### Implementation 3-Relay UE Deciding to Participate Procedure

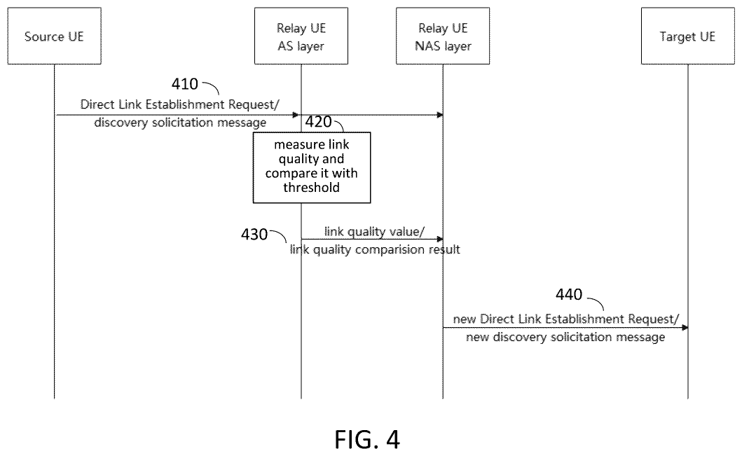

This implementation discusses the scenario when the relay UE receives the Direct Link Establishment Request message or discovery solicitation message from the source UE. The following operations are performed at the relay UE. FIG. 4 shows a schematic diagram illustrating example operations including deciding to participate the procedure based on some implementations of the disclosed technology.

Operation 410: The relay UE receives the Direct Link Establishment Request message or discovery solicitation message from the source UE. The Direct Link Establishment Request message and the discovery solicitation message can be those discussed in the Operations 230 and 330 and the descriptions above can be applied. The Direct Link Establishment Request message and discovery solicitation message may be communicated using Sidelink Signaling Radio Bearers (SL-SRB). In some implementations, the Direct Link Establishment Request may be transmitted using SL-SRB0, and the discovery message for UE-to-UE relay may be transmitted using SL-SRB5. If the relay_indication in discovery solicitation message is disabled, the relay UE will not provide the relay services for the source UE from which the discovery solicitation message is sent.

Operation 420: The AS layer of the relay UE measures the link quality between the source UE and the relay UE and then compare it with the link quality threshold. The threshold can be maximum threshold and/or minimum threshold. The threshold can be configured by network or system information or pre-configuration. If the relay UE is out of coverage, the threshold is configured by pre-configuration. If the relay UE is in RRC IDLE/INACTIVE state, the threshold is configured by system information. If the relay UE is in RRC CONNECTED state, the threshold is configured by system information or dedicated signaling (e.g., RRC signaling).

Operation 430: The AS layer of the relay UE sends link quality or comparison result to the relay UE NAS layer. If the measured link quality satisfies the threshold condition, the comparison result is determined as good. If the measured link quality does not satisfy the threshold condition, the comparison result is determined as bad. The threshold condition may be determined as satisfied if 1) the measured link quality is above the minimum threshold and below the maximum threshold when both the minimum threshold and the maxim threshold are provided, 2) if the measured link quality is above the minimum threshold when only minimum threshold is provided, or 3) if the measured link quality is below the maximum threshold when only maximum threshold is provided.

The process proceeds to the operation 440 when the measured link quality satisfies the threshold condition. Since the relay UE can participate the relay services by establishing the link between the relay UE and the target UE when the measured link quality satisfies the threshold condition, the operations for measuring the link quality and comparing it with the threshold condition may be considered as processes for the relay UE to decide to participate the relay service procedure. Thus, the relay UE decides to participate the relay service procedure based on whether the measured link quality satisfies the threshold condition. In some implementations, when the relay UE has received the Direct Link Establishment Request message, the decision to participate the relay service procedure can be also made based on the relay_indication field included in the Direct Link Establishment Request message. Thus, the relay UE which has received the Direct Link Establishment Request message can determine to participate the relay service procedure when the field included in the Direct Link Establishment Request message allows the relay services and the measured link quality satisfies the threshold condition.

Operation 440: The relay UE broadcasts the Direct Link Establishment Request message or discovery solicitation message to the target UE. Except that the Direct Link Establishment Request message and the discovery solicitation message is sent from the relay UE instead of the source UE, the similar descriptions to those discussed for the operation 230 are applied to the operation 430.

### Implementation 4-Stateful U2U Relay

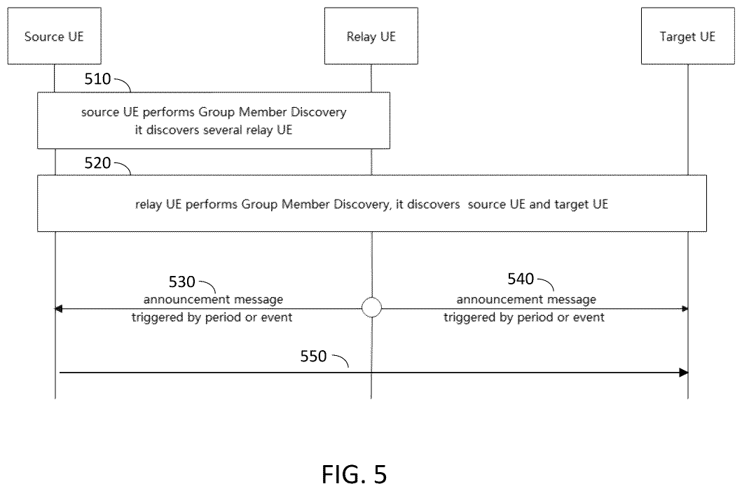

This implementation discusses the scenario when the source UE finds the relay UE based on the Group Member Discovery procedure. FIG. 5 shows a schematic diagram illustrating example operations using Group Member Discovery procedures based on some implementations of the disclosed technology.

Operation 510: The source UE performs the Group Member Discovery procedure. The Group Member Discovery procedure is performed either Model A (announce/monitor) or Model B (discovuer/discovercc). The Model A procedure includes a single message (announcement) that is periodically broadcasted by the announcing UE. The Model B procedure is performed with two messages: a solicitation message (typically broadcasted or groupcasted) and a response message (typically unicasted). Since the Model A procedure and the model B procedure are well known in the art, the detailed descriptions will be skipped. The Group Member Discovery procedure enables a ProSe-enabled UE to detect and identify another ProSe-enabled UE In the operation 410, the source UE discovers the relay UEs as its neighbours.

Operation 520: The relay UE performs the Group Member Discovery procedure. As discussed for the operation 510, the Group Member Discovery procedure may be performed either Model A (announce/monitor) or Model B (discovuer/discoveree). In the operation 520, the Relay UE discovers two UEs in vicinity, i.e., the source UE and the target UE.

Operations 530 and 540: The relay UE which can act as a UE-to-UE relay makes the announcement. In some implementations, the announcement is made by transmitting announcement messages periodically. In some other implementations, the announcement is triggered by an event. When the announcement messages are transmitted periodically, the interval for the periodic transmission of the announcement message can be configured by network or system information or pre-configuration. If the relay UE is out of coverage, the interval is configured by pre-configuration. If the relay UE is in RRC IDLE/INACTIVE state, the interval should is configured by system information. If the relay UE is in RRC CONNECTED state, the interval is configured by system information or dedicated signaling (e.g., RRC signaling). When the announcement is triggered by the event, the triggering event can be the change of the neighbour list of the relay UE.

Operation 550: Based on the information received in the operation 530, the source UE decides to establish an one-to-one communication link with the relay UE and engages the communication with the target UE via the relay UE.

### Implementations 5—Target UE Performing Relay Selection

Implementations 5A to 5C discuss techniques for selecting a relay UE when multiple relay UEs are available.

### Implementation 5A

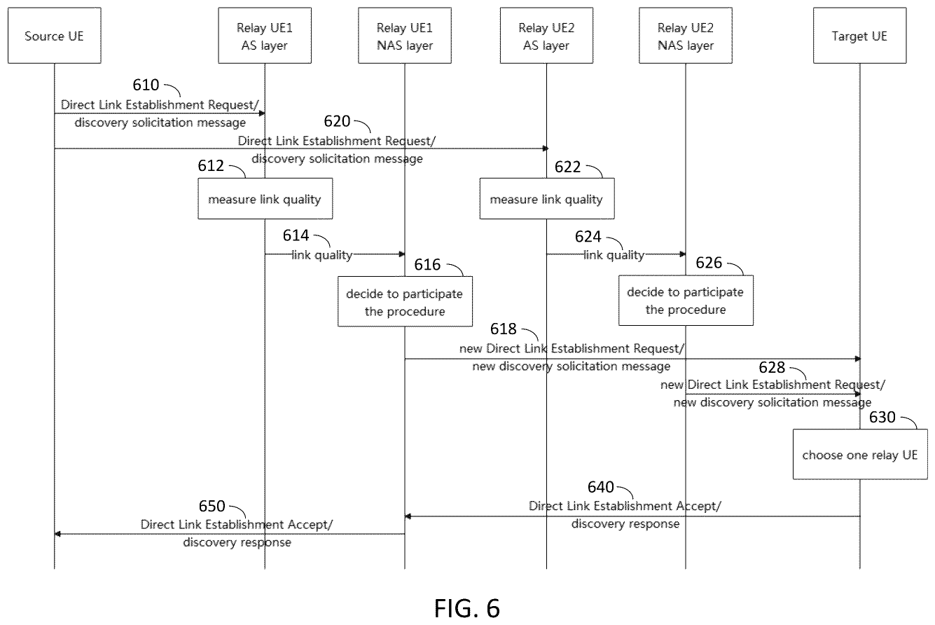

Implementation 5A will be described with reference to FIG. 6 which shows a schematic diagram illustrating example operations including selecting one relay UE based on some implementations of the disclosed technology.

Operations 610 and 620: The source UE sends the Direct Link Establishment Request message or discovery solicitation message. In FIG. 6, the Direct Link Establish Request message or discovery solicitation messages are sent to relay UE1 and the relay UE2. The descriptions for the Direct Link Establishment Request message and the discovery solicitation message as discussed in the previous implementations can be applied.

Operations 612 and 622: At the operation 612, the relay UE1, which has received the Direct Link Establishment Request message or discovery solicitation message from the source UE, measures the link quality between the source UE and the relay UE1. At the operation 622, the relay UE2, which has received the Direct Link Establishment Request message or discovery solicitation message from the source UE, measures the link quality between the source UE and the relay UE2.

Operations 614 and 624: At the operation 614, the AS layer of the relay UE 1 sends the link quality between the relay UE1 and the source UE to the NAS layer of the relay UE1. At the operation 624, the AS layer of the relay UE2 sends the link quality between the relay UE2 and the source UE to the NAS layer of the relay UE2. The link quality can correspond to link quality value or enumerate value (each enumerated value represents a range of link quality and the correspondence is determined in spec).

Operations 616 and 626: At the operation 616, the relay UE1 decides to participate the relay service procedure. At the operation 626, the relay UE2 decides to participate the procedure. The decision to participate the relay service procedure may correspond to measuring the link quality and comparing it with the threshold condition as discussed in relation to Implementation 3.

Operations 618 and 628: Upon deciding to participate the relay service procedure, each of the relay UE1 and the relay UE2 adds the link quality information about the link between the corresponding relay UE and the source UE into the new Direct Link Establishment Request message or discovery solicitation message. The link quality can be link quality value or enumerate value (each enumerated value represents a range of link quality and the correspondence is determined in spec). At the operation 618, the relay UE1 sends, to the target UE, the new Direct Link Establishment Request message or discovery solicitation message, which includes the link quality information about the link between the relay UE1 and the source UE. At the operation 628, the relay UE2 sends, to the target UE, the new Direct Link Establishment Request message or discovery solicitation message, which includes the link quality information about the relay UE2 and the source UE.

Operation 630: The target UE, which has received several relay UE's Direct Link Establishment Request message or discovery solicitation message from the same source UE, selects one relay UE. The selection may be made based on the link quality information included in the Direct Link Establishment Request message or discovery solicitation message.

Operation 640: The target UE sends the Direct Link Establishment Accept message or discovery response message to the NAS layer of the Relay UE1 which is selected by the target UE as the relay UE. The Direct Link Establishment Accept message or discovery response message may correspond to the response to the new Direct Link Establishment Request message or discovery solicitation message transmitted at the operation 618.

Operation 650: The NAS layer of the relay UE1 sends the Direct Link Establishment Accept message or discovery response message to the source UE. The Direct Link Establishment Accept message or discovery response message may correspond to the response to the Direct Link Establishment Request message or discovery solicitation message transmitted at the operation 610.

### Implementation 5B

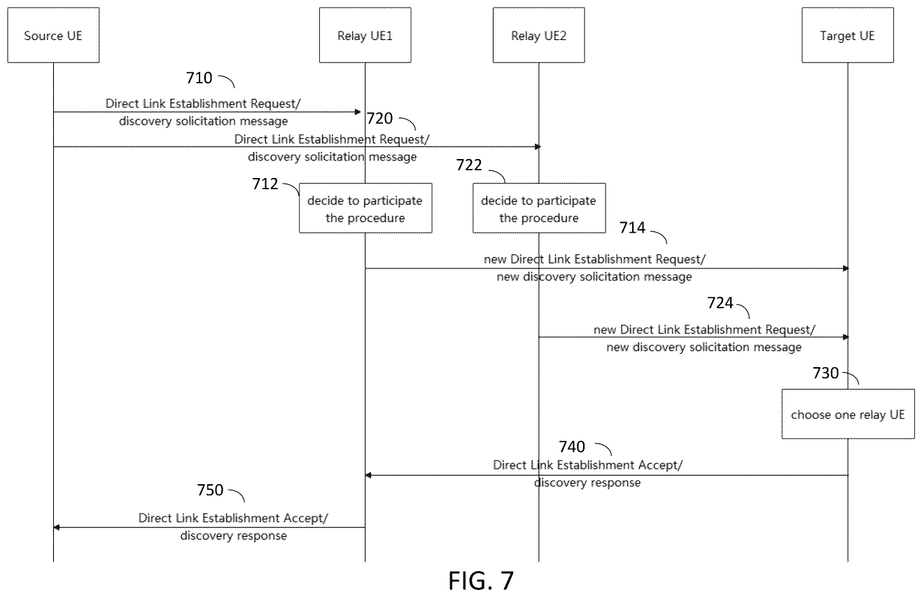

Implementation 5B will be described with reference to FIG. 7 which shows a schematic diagram illustrating example operations including selecting one relay UE based on some implementations of the disclosed technology.

Operations 710 and 720: The source UE sends the Direct Link Establishment Request message or discovery solicitation message that include at least one of a mode (e.g., whether the source UE is in IC (in coverage) or OOC (out of coverage)), PCI (physical cell ID), or gNB-ID of the source UE.

Operations 712 and 722: At the operation 712, the relay UE1, which has received the Direct Link Establishment Request message or discovery solicitation message from the source UE, decides to participate the relay service procedure. At the operation 722, the relay UE2, which has received the Direct Link Establishment Request message or discovery solicitation message from the source UE, decides to participate the relay service procedure. As discussed above, the relay UE can decide to participate the relay service procedure based on link quality. The descriptions for the operations 612, 622, 614, 624, 616 and 626 can be applied to the operations 712 and 722.

Operations 714 and 724: At the operations 714 and 724, each of the relay UE1 and the relay UE2 sends, to the target UE, the new Direct Link Establishment Request message or discovery solicitation message, which includes at least one of the mode (e.g., whether the source UE is in IC (in coverage) or OOC (out of coverage)), PCI (physical cell ID), or gNB-ID of the source UE.

Operation 730: The target UE, which has received several relay UE's Direct Link Establishment Request message or discovery solicitation message from the same source UE, selects one relay UE. The selection may be made based on at least one of the mode (e.g., whether the source UE is in IC (in coverage) or OOC (out of coverage)), PCI (physical cell ID), or gNB-ID of the source UE, which is included in the Direct Link Establishment Request message or discovery solicitation message.

Operations 740 and 750 correspond to the operations 640 and 650, respectively and thus the similar descriptions can be applied.

### Implementation 5C

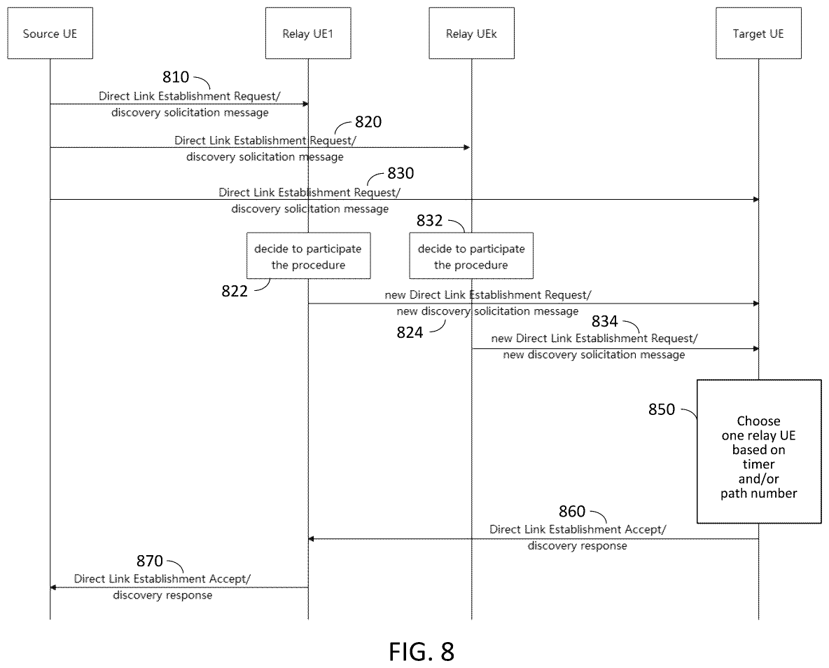

Implementation 5C will be described with reference to FIG. 8 which shows a schematic diagram illustrating example operations including selecting one relay UE based on some implementations of the disclosed technology.

Operations 810, 820 and 830: The source UE sends the Direct Link Establishment Request message or discovery solicitation message which includes path selection information. At the operations 810, 820 and 830, the source UE sends the Direct Link Establishment Request message or discovery solicitation message with path selection information to the relay UE1, the relay UEk, and the target UE. For example, the path selection information includes a maximum number of paths.

Operations 822 and 832: At the operation 822, the relay UE1, which has received the Direct Link Establishment Request message or discovery solicitation message from the source UE, decides to participate the relay service procedure. At the operation 832, the relay UEk, which has received the Direct Link Establishment Request message or discovery solicitation message from the source UE, decides to participate the relay service procedure. As discussed above, the relay UE can decide to participate the relay service procedure based on link quality.

Operations 824 and 834: At the operations 824 and 834, each of the relay UE1 and the relay UEk sends, to the target UE, the new Direct Link Establishment Request message or discovery solicitation message including path selection information.

Operation 850: The target UE, which has received several relay UE's Direct Link Establishment Request message or discovery solicitation message from the same source UE, selects one relay UE. In this implementations, the target UE chooses one relay UE based on timer and/or the path number information. The timer and/or the path number information helps the target UE to determine a timing to choose one relay UE. The target UE keeps a timer which starts when the target UE receives the message from the source UE for the first time. The target UE also has a known value for the timer to expire. The target UE can also receive the path selection information including a maximum number included in the new Direct Link Establishment Request or discovery solicitation message. The path number records the number of times that the target UE receives the message from the source UE either directly sent by source UE or transferred from the relay UE. Each time when the target UE receive such message, the path number increases by 1. The target UE chooses one relay UE when 1) the time expires or 2) path number reaches to the maximum number.

In some implementations, the timer and the maximum path number can be configured by network or system information or pre-configuration. If the relay UE is out of coverage, the timer and the maximum path number may be configured by pre-configuration. If the relay UE is in RRC IDLE/INACTIVE state, the timer and the maximum path number is configured by system information. If the relay UE is in RRC CONNECTED state, the timer and the maximum path number is configured by system information or dedicated signaling (e.g., RRC signaling).

Operations 860 and 870 correspond to the operations 640 and 650, respectively and thus the similar descriptions can be applied

### Implementation 6-Source UE Performing Relay Selection

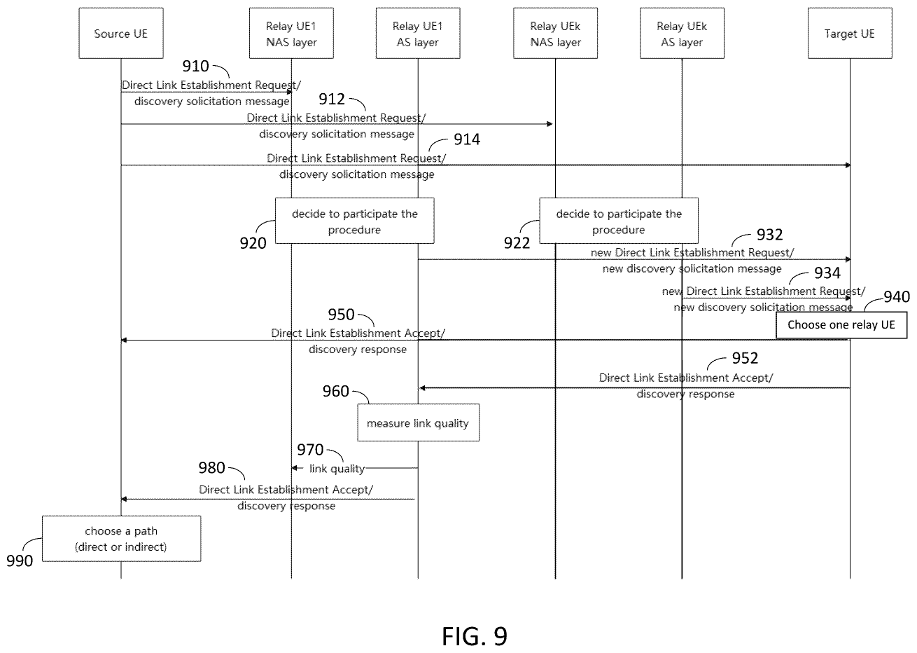

This implementation discusses the scenario when the direct link between the source UE and the target UE is available and also there is one or more relay UEs available to assist to establish the indirect link between the source UE and the target UE. In this case, the source UE can select the option to proceed between the direct link option and the indirect link option. FIG. 9 shows a schematic diagram illustrating example operations including selection of the relay UE by the source UE.

Operations 910, 912 and 914: The source UE sends the Direct Link Establishment Request message or discovery solicitation message. At the operations 910, 912 and 914, the source UE sends the Direct Link Establishment Request message or discovery solicitation message to the relay UE1, the relay UEk, and the target UE.

Operations 920 and 922: At the operation 920, the relay UE1, which has received the Direct Link Establishment Request message or discovery solicitation message from the source UE, decides to participate the relay service procedure. At the operation 922, the relay UEk, which has received the Direct Link Establishment Request message or discovery solicitation message from the source UE, decides to participate the relay service procedure. As discussed above, the relay UE can decide to participate the relay service procedure based on link quality.

Operations 932 and 934: At the operations 932 and 934, each of the relay UE1 and the relay UEk sends, to the target UE, the new Direct Link Establishment Request message or discovery solicitation message.

Operation 940: The target UE, which has received the Direct Link Establishment Request message or discovery solicitation message from both the relay UEs and the source UE, chooses one relay UE. The target selection can select the relay UE based on various implementations, for example, as discussed in Implementations 5A to 5C.

Operations 950 and 952: The target UE sends the Direct Link Establishment Accept message or discovery response message to the Relay UE1 which is selected by the target UE as the relay UE and the source UE.

Operations 960, 970 and 980: At the operation 960, the relay UE, which has received the Direct Link Establishment Accept message or discovery response message from the target UE, measures link quality between the relay UE and the target UE. At the operation 970, the link quality indication is sent to the NAS layer of the relay UE1 from the AS layer from the relay UE1. At the operation 980, the AS layer of the Relay UE1 sends the Direct Link Establishment Accept message or discovery response message to the source UE, which includes at least link quality between the relay UE and the target UE, mode information (whether the target UE is in IC or OOC), PCI, gNB-ID of the target UE. The mode information is obtained from the target UE.

Operation 990: The source UE, which has received the Direct Link Establishment Accept message or discovery response message from both the target UE and the relay UE, chooses the option to engage the communication with the target UE. The selection of the option between the direct link option and the indirect link option is implemented according to the source UE. In some implementation, the contents in the Direct Link Establishment Accept message or discovery response message can assist such selection. The selected option corresponds to engage the communication with the target UE through either the direct link or the indirect link via the Relay UE1.

### Implementation 7-Radio Link Failure (RLF)

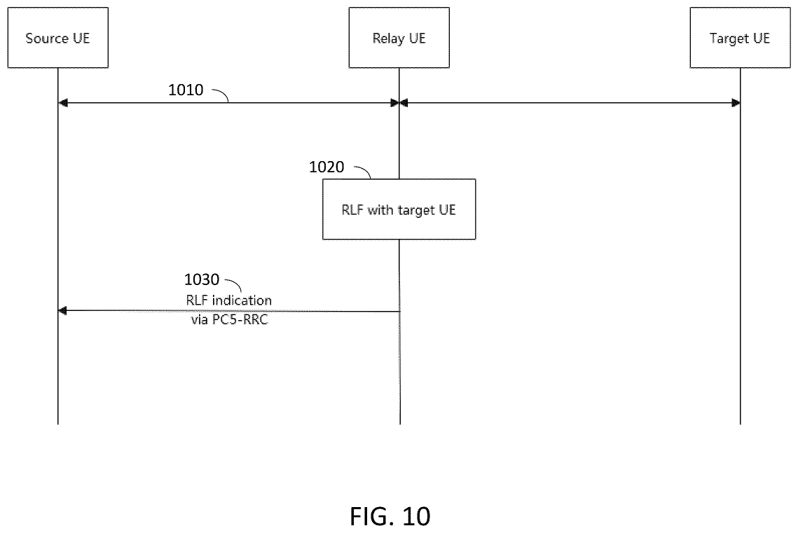

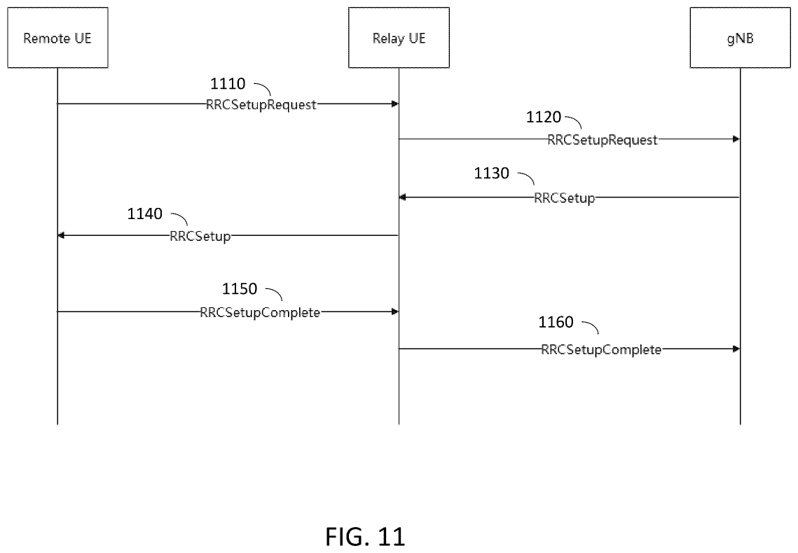

This implementation discusses the scenario that the radio link failure (RLF) occurs at the relay UE after the relay UE is selected to assist the communication between the source UE and the target UE. FIG. 10 shows a schematic diagram illustrating example operations including informing the occurrence of the RLF.

Operation 1010: The link between the source UE and the target UE is established via the relay UE.

Operation 1020: The relay UE detects the radio link failure (RLF) for the link with the target UE.

Operation 1030: The relay UE informs the source UE the RLF of the link between the relay UE and the target UE. In some implementations, the RLF indication may be sent via PC5-RRC.

### Implementation 8-Remote UE's RRC Connection Establishment

The implementation discusses the UE-to-Network relay scenario. In this implementations, the remote UE communicates with the network (gNB) through the relay UE.

Operations 1110 and 1120: The remote UE transmits the RRC Setup Request message to the gNB via the relay UE. At the operation 1110, the remote UE transmits the RRC Setup Request message to the relay UE. At the operation 1120, the relay UE transmits the RRC setup Request message to the gNB. In some implementations, the specified (fixed) configuration is used for the configuration of PC5 RLC (Radio Link Control) channel and network configuration is used for the configuration of Uu RLC channel.

Operation 1130 and 1140: The gNB transmits the RRC Setup message to the remote UE via the relay UE. At the operation 1130, the gNB transmits the RRC Setup message to the relay UE. At the operation 1140, the relay UE transmits the RRC Setup message to the remote UE. In some implementations, the PC5 RLC channel configuration for remote UE's SRB1 may be included in the RRC Setup message sent from gNB to the remote UE via the relay UE. e.g. s1-ConfigDedicatedNR-r16 IE. In some implementations, the IE SL-ConfigDedicatedNR specifying the dedicated configuration information for NR sidelink communication/discovery may be included in the RRC Setup message sent from gNB to the remote UE via the relay UE. In some implementations, the SRAP (Sidelink Relay Adaptation Protocol) configuration, e.g. SL-SRAP-Config 1E, may be included in the RRC Setup message sent from gNB to the remote UE via the relay UE. . . . The IE SL-SRAP-Config is used to set the configurable SRAP parameters used by L2 U2N Relay UE and L2 U2N Remote UE. Thus, in some implementations, the RRC Setup messages transmitted at the operations 1130 and 1140 includes PC5 RCL channel configuration information (e.g., IE SL-ConfigDedicatedNR) and/or the parameter information (e.g., IE SL-SRAP-Config).

Operations 1150 and 1160: At the operation 1150, the remote UE transmits the RRC Setup Complete message to the relay UE. The remote UE use the configuration in RRC Setup message to transmit RRCSetupComplete message to the relay UE. At the operation 1160, the relay UE transmits the RRC Setup Complete message to the gNB. In some implementations, the configuration included in RRC Setup message, for example, IE SL-ConfigDedicatedNR and SL-SRAP-Config 1E, is used for the remote UE to send RRCSetupComplete to the relay UE, and then the relay UE forwards the remote UE's RRCSetupComplete to the gNB using legacy technology. In some implementations, the added configuration, for example, IE SL-ConfigDedicatedNR and SL-SRAP-Config 1E, may be used only on the PC5 link between the remote UE and the relay UE.

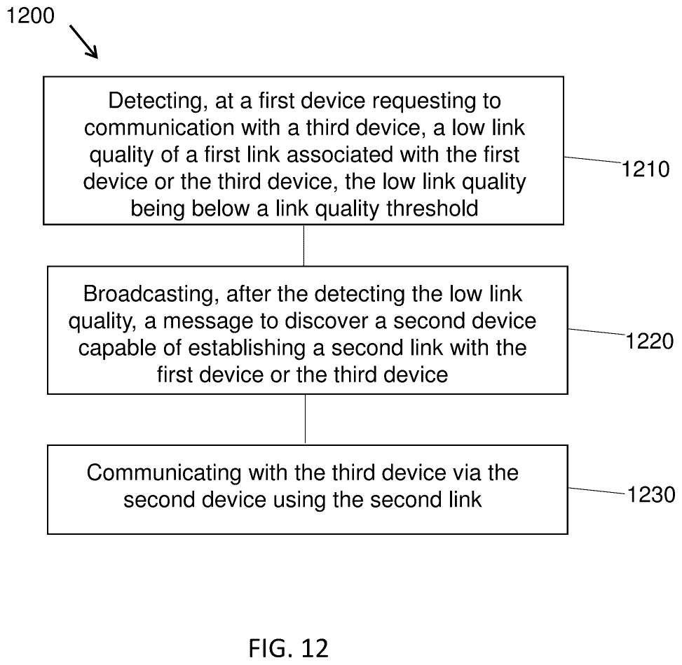

FIG. 12 illustrates a flowchart showing an example method of wireless communication based on some implementations of the disclosed technology. The method 1200 includes, at the operation 1210, detecting, at a first device requesting to communication with a third device, a low link quality of a first link associated with the first device or the third device, the low link quality being below a link quality threshold. The method 1200 further includes, at the operation 1220, broadcasting, after the detecting the low link quality, a message to discover a second device capable of establishing a second link with the first device or the third device. The method 1200 further includes, at the operation 1230, communicating with the third device via the second device using the second link.

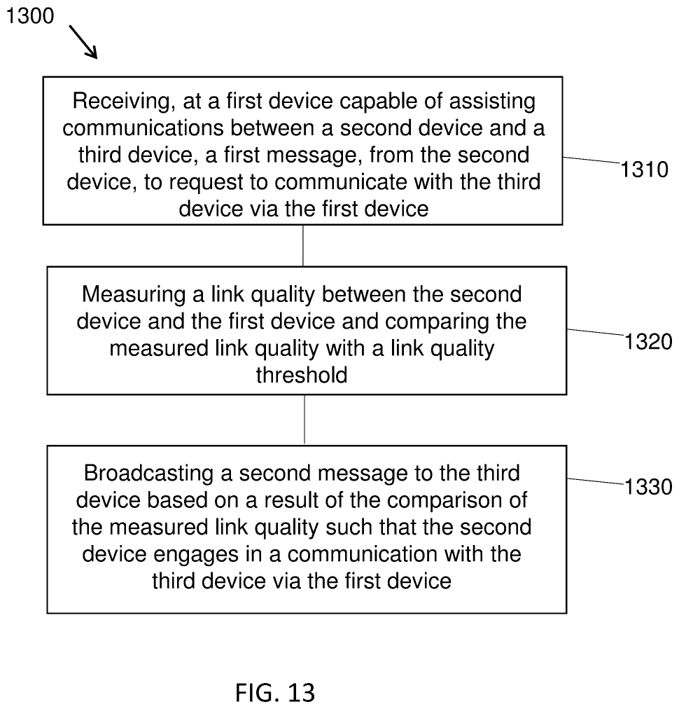

FIG. 13 illustrates a flowchart showing another example method of wireless communication based on some implementations of the disclosed technology. The method 1300 includes, at the operation 1310, receiving, at a first device capable of assisting communications between a second device and a third device, a first message, from the second device, to request to communicate with the third device via the first device. The method 1300 further includes, at the operation 1320, measuring a link quality between the second device and the first device and comparing the measured link quality with a link quality threshold. The method 1300 further includes, at the operation 1330, broadcasting a second message to the third device based on a result of the comparison of the measured link quality such that the second device engages in a communication with the third device via the first device.

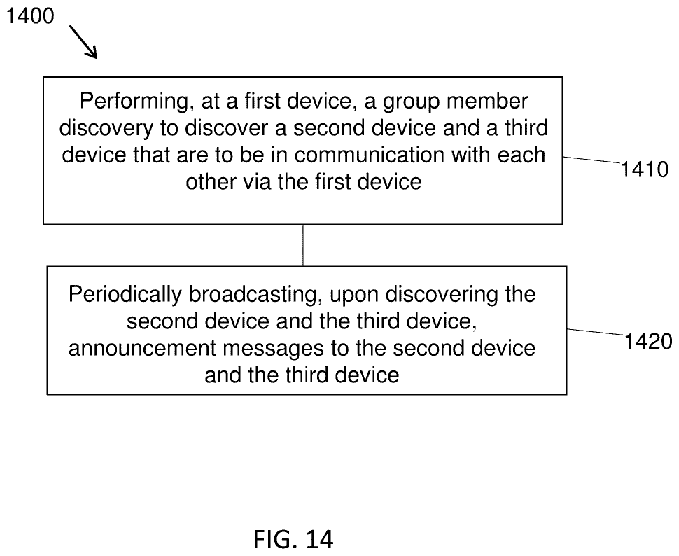

FIG. 14 illustrates a flowchart showing another example method of wireless communication based on some implementations of the disclosed technology. The method 1400 includes, at the operation 1410, performing, at a first device, a group member discovery to discover a second device and a third device that are to be in communication with each other via the first device. The method 1400 further includes, at the operation 1420, periodically broadcasting, upon discovering the second device and the third device, announcement messages to the second device and the third device.

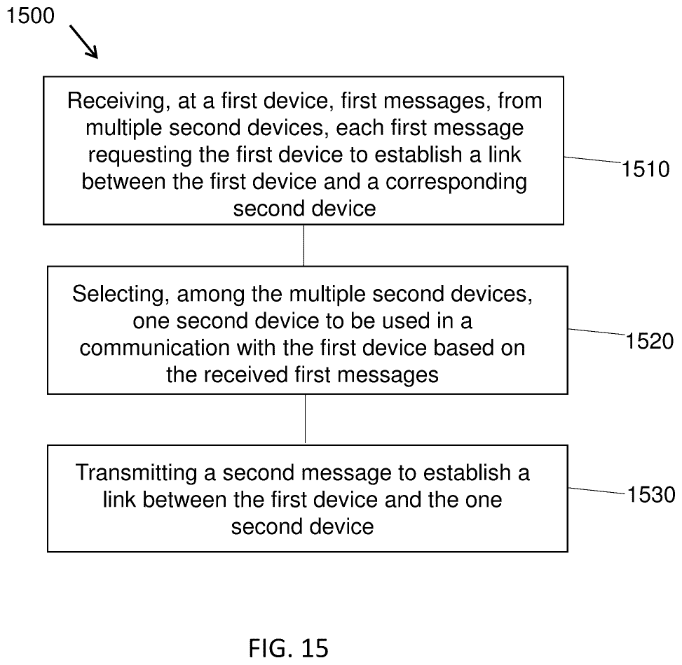

FIG. 15 illustrates a flowchart showing another example method of wireless communication based on some implementations of the disclosed technology. The method 1500 includes, at the operation 1510, receiving, at a first device, first messages, from multiple second devices, each first message requesting the first device to establish a link between the first device and a corresponding second device. The method 1500 further includes, at the operation 1520, selecting, among the multiple second devices, one second device to be used in a communication with the first device based on the received first messages. The method 1500 further includes at the operation 1530, transmitting a second message to establish a link between the first device and the one second device.

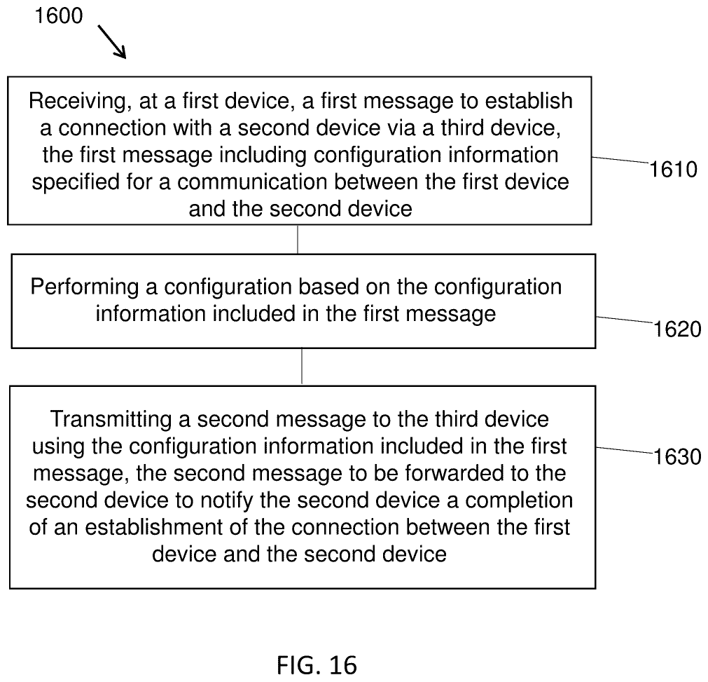

FIG. 16 illustrates flowchart showing another example method of wireless communication based on some implementations of the disclosed technology. The method 1600 includes, at the operation 1610, receiving, at a first device, a first message to establish a connection with a second device via a third device, the first message including configuration information specified for a communication between the first device and the second device. The method 1600 further includes, at the operation 1620, performing a configuration based on the configuration information included in the first message. The method 1600 further includes, at the operation 1630, transmitting a second message to the third device using the configuration information included in the first message, the second message to be forwarded to the second device to notify the second device a completion of an establishment of the connection between the first device and the second device.

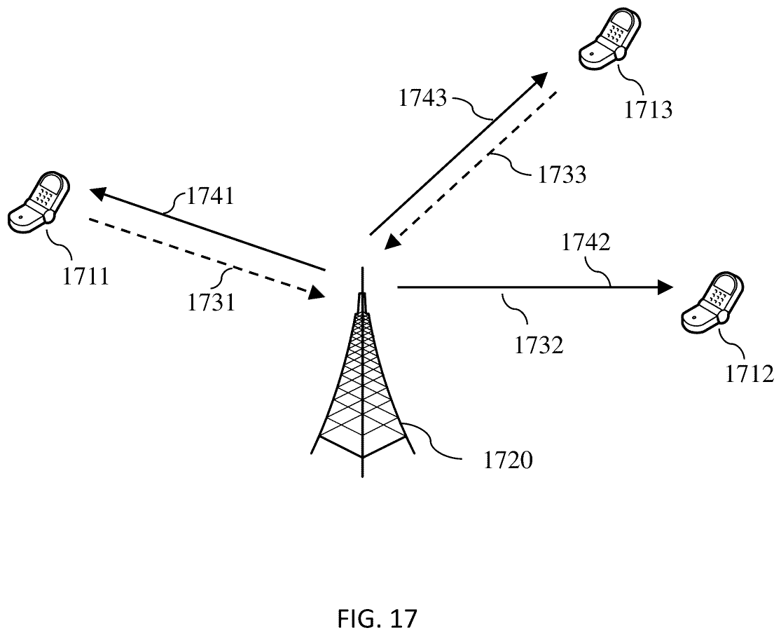

The implementations as discussed above will apply to a wireless communication. FIG. 17 shows an example of a wireless communication system (e.g., a 5G or NR cellular network) that includes a base station 1720 and one or more user equipment (UE) 1711, 1712 and 1713. In some embodiments, the UEs access the BS (e.g., the network) using implementations of the disclosed technology 1731, 1732, 1733), which then enables subsequent communication (1741, 1742, 1743) from the BS to the UEs. The UE may be, for example, a smartphone, a tablet, a mobile computer, a machine to machine (M2M) device, an Internet of Things (IoT) device, and so on.

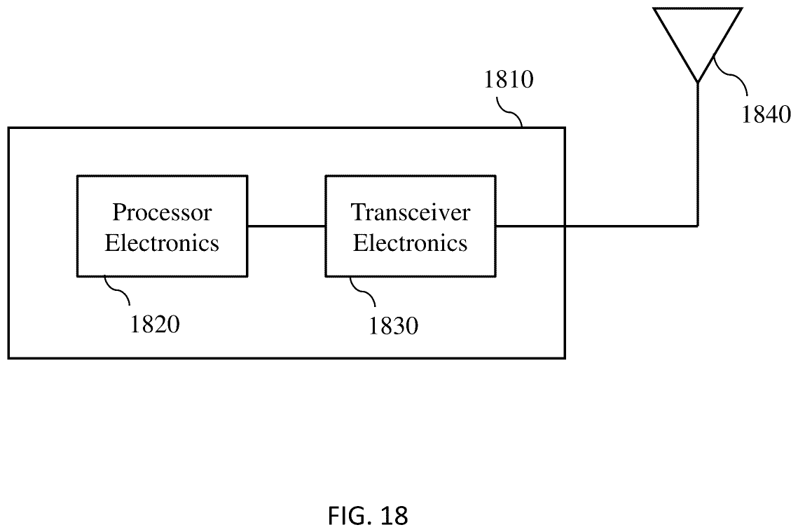

FIG. 18 shows an example of a block diagram representation of a portion of an apparatus. An apparatus 1810 such as a base station or a user device which may be any wireless device (or UE) can include processor electronics 1820 such as a microprocessor that implements one or more of the techniques presented in this document. The apparatus 1810 can include transceiver electronics 1830 to send and/or receive wireless signals over one or more communication interfaces such as antenna 1840. The apparatus 1810 can include other communication interfaces for transmitting and receiving data. The apparatus 1810 can include one or more memories (not explicitly shown) configured to store information such as data and/or instructions. In some implementations, the processor electronics 1820 can include at least a portion of transceiver electronics 1830. In some embodiments, at least some of the disclosed techniques, modules or functions are implemented using the apparatus 1810.

It is intended that the specification, together with the drawings, be considered exemplary only, where exemplary means an example and, unless otherwise stated, does not imply an ideal or a preferred embodiment. As used herein, the use of “or” is intended to include “and/or”, unless the context clearly indicates otherwise.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
detecting, at a first device requesting to communication with a third device, a low link quality of a first link associated with the first device or the third device, the low link quality being below a link quality threshold;
broadcasting, after the detecting the low link quality, a message to discover a second device capable of establishing a second link with the first device or the third device; and
communicating with the third device via the second device using the second link.

2. The method of claim 1, wherein the link quality threshold is configured by network or system information or pre-configured, or wherein the link quality threshold is included in a sidelink control channel.

3. The method of claim 1, wherein the first link associated with the first device or the third device is a link between the first device and the third device, or wherein the first link associated with the first device is a link between the first device and a fourth device via which the first device engages in communication with the third device.

4. The method of claim 1, wherein the detecting of the low link quality includes measuring the link quality of the first link, or receiving a low link indication.

5. The method of claim 1, further comprising:
receiving, at the first device, a first message, from the third device to establish a direct link between the first device and the third device;
receiving a second message from the second device to establish an indirect link between the first device and the third device via the second device; and
selecting, according to a rule, one of the direct link or the indirect link to communicate with the third device.

6. The method of claim 5, wherein the receiving of the second message receives the second message with at least link quality between the second device and the third device, a mode regarding whether the third device is in coverage or out of coverage, a physical cell ID of the third device, or network ID of the third device.

7. The method of claim 6, further comprising, prior to the receiving of the first message:
sending, to the third device, a third message to request to establish the direct link, or
sending, to the second device, a fourth message to request to establish the indirect link.

8. A method of wireless communication, comprising:
receiving, at a first device capable of assisting communications between a second device and a third device, a first message, from the second device, to request to communicate with the third device via the first device;
measuring a link quality between the second device and the first device and comparing the measured link quality with a link quality threshold; and
broadcasting a second message to the third device based on a result of the comparing of the measured link quality such that the second device engages in a communication with the third device via the first device.

9. The method of claim 8, wherein the link quality threshold is configured by network or system information or pre-configured.

10. The method of claim 8, further comprising:
detecting an occurrence of a radio link failure in communicating with the third device; and
notifying the second device of the occurrence of the radio link failure, andwherein the occurrence of the radio link failure is notified via a sidelink control channel.

11. The method of claim 8, comprising:
performing, at the first device, a group member discovery to discover the second device and the third device that are to be in communication with each other via the first device; and
periodically broadcasting, upon discovering the second device and the third device, announcement messages to the second device and the third device.

12. The method of claim 11, wherein a period of broadcasting the announcement messages is configured by network or system information or pre-configured, or wherein the broadcasting announcement message is triggered by an event.

13. The method of claim 8, further comprising:
receiving, at the first device, first messages, from multiple second devices including the second device, each first message requesting the first device to establish a link between the first device and a corresponding second device;
selecting, among the multiple second devices, the second device to be used in a communication with the first device based on the received first messages; and
transmitting a second message to establish a link between the first device and the second device.

14. The method of claim 13, wherein the selecting one of the multiple second device is based on i) link quality information, ii) based on information that include at least one of a mode regarding whether a corresponding third device is in coverage or out of coverage, a physical cell ID of the third device, or network ID of the third device, or iii) based on at least one of timer or path selection information including a maximum number of paths.

15. The method of claim 14, wherein the first device selects the one of the multiple second device when 1) the timer expires or 2) path number corresponding to a number of times that the first device receives a message directly or indirectly from the third device reaches the maximum number of paths.

16. An apparatus of wireless communication, comprising a processor operating as a first device requesting to communicate with a third device and configured to:
detect, a low link quality of a first link associated with the first device or the third device, the low link quality being below a link quality threshold;
broadcast, after the detecting the low link quality, a message to discover a second device capable of establishing a second link with the first device or the third device; and
communicate with the third device via the second device using the second link.

17. The apparatus of claim 16, wherein the link quality threshold is configured by network or system information or pre-configured, or wherein the link quality threshold is included in a sidelink control channel.

18. The apparatus of claim 16, wherein the first link associated with the first device or the third device is a link between the first device and the third device, or wherein the first link associated with the first device is a link between the first device and a fourth device via which the first device engages in communication with the third device.

19. The apparatus of claim 16, wherein the processor is further configured to:
receive a first message, from the third device to establish a direct link between the first device and the third device;
receive a second message from the second device to establish an indirect link between the first device and the third device via the second device; and
select, according to a rule, one of the direct link or the indirect link to communicate with the third device.

20. The apparatus of claim 19, wherein the processor is configured to receive the second message with at least link quality between the second device and the third device, a mode regarding whether the third device is in coverage or out of coverage, a physical cell ID of the third device, or network ID of the third device.
